(19) United States
(12) Patent Application Publication
(10) Pub. No.: US 2026/0225452 A1
(43) Pub. Date: Aug. 6, 2026

(54) CONTROL APPARATUS FOR VEHICLE

(71) Applicant: TOYOTA JIDOSHA KABUSHIKI KAISHA, Toyota-shi (JP)

(72) Inventors: Satoshi SASAKI, Nagoya-shi (JP); Toshifumi YAMAKAWA, Okazaki-shi (JP)

(73) Assignee: TOYOTA JIDOSHA KABUSHIKI KAISHA, Toyota-shi (JP)

(21) Appl. No.: 19/529,913

(22) Filed: Feb. 4, 2026

(30) Foreign Application Priority Data
Feb. 6, 2025 (JP) 2025-018797

(51) Int. Cl. B60L 3/00; B60L 15/02; H02M 1/088; H02M 7/797

(52) U.S. Cl. CPC B60L 3/0038; B60L 3/0061; B60L 15/025; H02M 1/088; B60L 2210/14; B60L 2210/40; B60L 2220/42; B60L 2240/429; H02M 7/797

(57) ABSTRACT

A vehicle control apparatus in which three electric-current characteristics, each of which is a characteristic of an electric current flowing to a corresponding one of three electric machines and each of which is acquired when a discharge control is executed for discharging charge of a capacitor through the corresponding one of the three electric machines, are compared with one another. When it is determined that one of the three electric-current characteristics is deviated from the other two by at least a predetermined extent, an output value of a corresponding one of current sensors corresponding to the one of the three electric-current characteristics, which is determined to be deviated from the other two, is corrected.

This application claims priority from Japanese Patent Application No. 2025-018797 filed on Feb. 6, 2025, the disclosure of which is herein incorporated by reference in its entirety.

### FIELD OF THE INVENTION

The present invention relates to a control apparatus for a vehicle that includes three electric machines and a plurality of current sensors each configured to detect an electric current flowing to a corresponding one of the electric machines.

### BACKGROUND OF THE INVENTION

There is well known a control apparatus for a vehicle that includes (i) an electric storage device, (ii) an electric machine, (iii) an electric-power control device configured to supply an electric power from the electric storage device to the electric machine and (iv) a current sensor configured to detect an electric current flowing from the electric-power control device to the electric machine. A motor control apparatus disclosed in JP6363221B2 is an example of such a control apparatus. In the motor control apparatus disclosed in this Japanese Patent Publication, a detected value of the current sensor, which is acquired when the electric current is not flowing to an electric motor as the electric machine, is used as an offset error value of the current sensor, and a detection error of the current sensor is corrected.

### SUMMARY OF THE INVENTION

There is a case in which the vehicle includes three electric machines to which the electric power is to be supplied from the electric storage device through the electric-power control device and a plurality of current sensors each configured to detect the electric current flowing to a corresponding one of the electric machines. In this case, although the detection error of each of the current sensors can be corrected as disclosed in the above-identified Japanese Patent Publication, errors and variations among the detected values of the respective current sensors cannot be suppressed.

The present invention was made in view of the background art described above. It is therefore an object of the present invention to provide a control apparatus for a vehicle, which is capable of suppressing errors and variations among detected values of a plurality of current sensors provided in the vehicle cannot be suppressed.

The object indicated above is achieved according to the present invention.

According to the present invention, there is provided a control apparatus for a vehicle that includes (i) an electric storage device, (ii) three electric machines, (iii) an electric-power control device which includes a capacitor connected with the electric storage device and which is configured to supply an electric power from the electric storage device to the three electric machines and (iv) a plurality of current sensors each of which is configured to detect an electric current flowing from the electric-power control device to a corresponding one of the three electric machines. The control apparatus includes: (a) a discharge controller configured, when connection of the capacitor with the electric storage device is cut off, to execute a discharge control for discharging charge of the capacitor through each one of the three electric machines by controlling the electric-power control device; and (b) a corrector configured to compare three electric-current characteristics each of which is a characteristic of the electric current flowing to a corresponding one of the three electric machines and each of which is acquired when the discharge control is executed through the corresponding one of the three electric machines, and is configured, when determining that one of the three electric-current characteristics is deviated from the other two of the three electric-current characteristics by at least a predetermined extent, to correct an output value of a corresponding one of the current sensors corresponding to the one of the three electric-current characteristics which is determined to be deviated from the other two.

In the control apparatus according to the invention, the three electric-current characteristics, each of which is the characteristic of the electric current flowing to the corresponding one of the three electric machines and each of which is acquired when the discharge control is executed through the corresponding one of the three electric machines, are compared with one another. When it is determined that one of the three electric-current characteristics is deviated from the other two of the three electric-current characteristics by at least the predetermined extent, i.e., by such an extent that requires a correction, the output value of the corresponding one of the current sensors corresponding to the one of the three electric-current characteristics, which is determined to be deviated from the other two, is corrected. Thus, it is possible to correct the output value of one of the current sensors which is considerably deviated from a design center as viewed on a distribution chart of errors (or variations) of the current sensors, and to suppress errors and variations among the plurality of current sensors.

### BRIEF DESCRIPTION OF THE DRAWINGS

FIG. 1 is a view showing a construction of a vehicle to which the present invention is applied, and also main portions of control functions and systems for performing various controls in the vehicle;

FIGS. 2A and 2B are for explaining a current circle, wherein FIG. 2A is a view showing, by way of examples, a motor current characteristic that is used for forming the current circle, and FIG. 2B is a view for explaining the formed current circle;

FIG. 3 is a view showing, by way of examples, the current circles for respective electric motors;

FIG. 4 is a flow chart showing main portions of control operations performed by an electronic control apparatus, namely, a control routine executed by the electronic control apparatus for suppressing errors and variations among detected values of respective current sensors; and

FIG. 5 is a view showing, by way of example, a distribution chart of errors (or variations) of current sensors.

### DETAILED DESCRIPTION OF PREFERRED EMBODIMENT

Hereinafter, there will be described preferred embodiment in detail with reference to the accompanying drawings.

### Embodiment

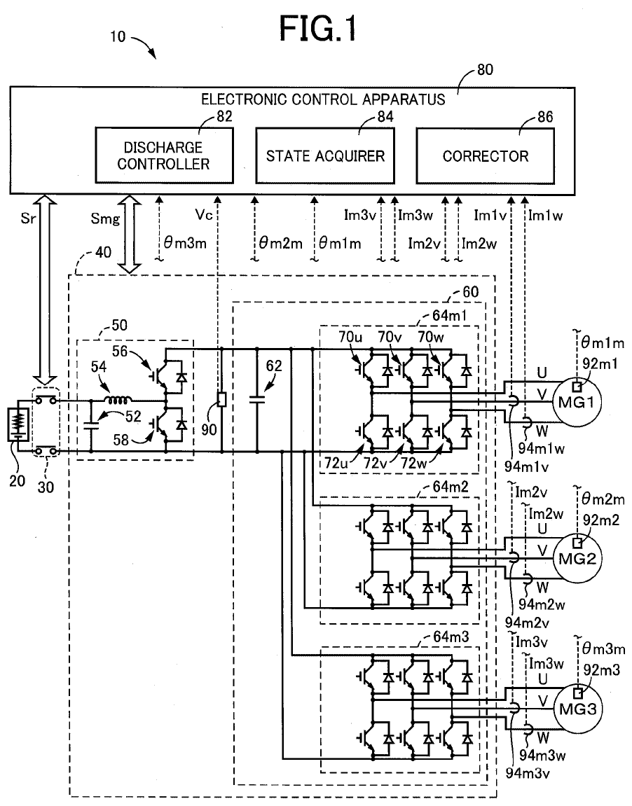

FIG. 1 is a view showing a construction of a vehicle 10 to which the present invention is applied, and also main portions of control functions and systems for performing various controls in the vehicle 10. As shown in FIG. 1, the vehicle 10 includes electric motors MG, a battery 20, a main relay 30, an electric-power control device 40 and an electronic control apparatus 80.

The electric motors MG correspond to “electric machines” recited in the appended claims. The electric motors MG include a first electric motor MG1, a second electric motor MG2 and a third electric motor MG3 as three electric machines. The electric motors MG are rotating electric machines, commonly known as motor-generators. The electric motors MG are three-phase AC electric motors in the present invention. The first electric motor MG1 functions as an electric generator that generates electricity by using a power of an engine (not shown), for example. Each of the second electric motor MG2 and the third electric motor MG3 function as a power source that generates a drive torque for driving the vehicle 10. For example, one of the second electric motor MG2 and the third electric motor MG3 drives front wheels, while the other of the second electric motor MG2 and the third electric motor MG3 drives rear wheels.

The battery 20 is a rechargeable DC power source, such as a high-voltage battery for driving the vehicle 10. The battery 20 corresponds to “electric storage device” recited in the appended claims. The main relay 30 is a relay provided in an electrical path between the battery 20 and the electric-power control device 40, so as to selectively connect and disconnect the electrical path. The main relay 30 is a relay switch that is to be switched between a disconnecting state for disconnecting the electrical path between the battery 20 and the electric-power control device 40 and a connecting state for connecting the electrical path between the battery 20 and the electric-power control device 40. The disconnecting state is an OFF state in which contacts of the main relay 30 are open. The connecting state is an ON state in which contacts of the main relay 30 are closed.

The electric motors MG are connected to the electric-power control device 40. The electric-power control device 40 controls an electric power transferred between the battery 20 and the electric motors MG. The electric-power control device 40 supplies the electric power from the battery 20 to each of the electric motors MG. The electric-power control device 40 supplies the electric power to the battery 20 by a power generation control of the electric motors MG, for example, by a regenerative control.

The electric-power control device 40 includes a boost converter 50 and an inverter 60. The boost converter 50 is connected to the battery 20 via the main relay 30. The boost converter 50 includes a filter capacitor 52, a reactor 54 and two switching elements 56, 58. The boost converter 50 is a step-up/step-down circuit that has functions of increasing a voltage of the battery 20 and supplying it to the inverter 60 and functions of reducing the voltage converted to DC by the inverter 60 and supplying it to the battery 20.

The inverter 60 is connected to the battery 20 via the boost converter 50 and the main relay 30. The electric motors MG are connected to the inverter 60. The inverter 60 includes a smoothing capacitor 62 and power modules 64.

The smoothing capacitor 62 is provided in the electrical path between the boost converter 50 and the power modules 64. The smoothing capacitor 62 is connected to the battery 20 via the boost converter 50 and the main relay 30. The smoothing capacitor 62 is provided to smooth the voltage in the electrical path in which the smoothing capacitor 62 is located. When the main relay 30 is in ON state, the smoothing capacitor 62 has a voltage substantially equal to the voltage increased by the boost converter 50. The smoothing capacitor 62 is connected to the battery 20, and correspond to “capacitor” recited in the appended claims.

The power modules 64 drive the electric motors MG. The power modules 64 include a first power module 64m1, a second power module 64m2 and a third power module 64m3. The first power module 64m1 drives the first electric motor MG1. The first power module 64m1 includes a plurality of switching elements 70, 72. In the first power module 64m1, the switching elements 70, 72 cooperate to form a three-phase bridge circuit for U, V and W phases. The switching elements 70 include switching elements 70u, 70v, 70w corresponding to the respective three phases. The switching elements 72 include switching elements 72u, 72v, 72w corresponding to the respective three phases. The switching elements 70, 72 are driven on and off to convert DC current into three-phase AC current. Each of the second power module 64m2 and the third power module 64m3 has substantially the same construction as the first power module 64m1, so that descriptions of the second power module 64m2 and the third power module 64m3 are not provided.

The inverter 60 converts the DC current supplied from the boost converter 50 into the AC current for driving the electric motors MG. The inverter 60 converts the AC current generated by the electric motors MG into the DC current. The inverter 60 corresponds to “inverter” recited in the appended claims, and is configured to drive each of the electric motors MG.

The electronic control apparatus 80 is a controller that performs various controls of the vehicle 10. The electronic control apparatus 80 includes a so-called microcomputer equipped with CPU, RAM, ROM and input/output interface, for example. The electronic control apparatus 80 performs various controls in the vehicle 10, with the CPU processing signals in accordance with programs pre-stored in the ROM while utilizing temporary storage function of the RAM. The electronic control apparatus 80 corresponds to “control apparatus” recited in the appended claims.

The electronic control apparatus 80 receives various signals based on the values detected by various sensors provided in the vehicle 10. The various sensors include a voltage sensor 90, rotary sensors 92 and current sensors 94. The rotary sensor 92 includes a first rotary sensor 92m1, a second rotary sensor 92m2 and a third rotary sensor 92m3. The current sensors 94 include a first V-phase current sensor 94m1v, a first W-phase current sensor 94m1w, a second V-phase current sensor 94m2v, a second W-phase current sensor 94m2w, a third V-phase current sensor 94m3v and a third W-phase current sensor 94m3w. The various signals include a capacitor voltage Vc, electric-motor rotation angles θmgm and electric motor currents Img. The electric-motor rotation angles θmgm include a first-electric-motor rotation angle θm1m, a second-electric-motor rotation angle θm2m and a third electric motor rotation angle θm3m. The electric motor currents Img include a first-electric-motor V-phase current Im1v, a first-electric-motor W-phase current Im1w, a second-electric-motor V-phase current Im2v, a second-electric-motor W-phase current Im2w, a third-electric-motor V-phase current Im3v and a third-electric-motor W-phase current Im3w.

The voltage sensor 90 is connected in parallel with the smoothing capacitor 62, and detects a capacitor voltage Vc that is a signal representing a voltage value of the smoothing capacitor 62.

The rotary sensors 92 are constituted by resolvers, for example, and are provided in the respective electric motors MG to detect the electric-motor rotation angles θmgm, which represent rotation angles of the respective electric motors MG. The electric-motor rotation angles θmgm are signals representing rotor positions corresponding to mechanical angles (also synonymous with rotation angles) of the respective electric motors MG. The first rotary sensor 92m1 is provided in the first electric motor MG1, and detects the rotor position of the first electric motor MG1. The first-electric-motor rotation angle θm1m represents the rotor position corresponding to the mechanical angle of the first electric motor MG1. The second rotary sensor 92m2 is provided in the second electric motor MG2, and detects the rotor position of the second electric motor MG2. The second-electric-motor rotation angle θm2m represents the rotor position corresponding to the mechanical angle of the second electric motor MG2. The third rotary sensor 92m3 is provided in the third electric motor MG3, and detects the rotor position of the third electric motor MG3. The third-electric-motor rotation angle θm3m represents the rotor position corresponding to the mechanical angle of the third electric motor MG3.

The current sensors 94 are provided in wires connecting the electric-power control device 40 and the electric motors MG. The current sensors 94 detect the electric motor currents Img that are electric currents supplied from the electric-power control device 40 to the electric motors MG, and correspond to “plurality of current sensors” recited in the appended claims. The electric motor currents Img are output values of the current sensors 94, and are signals representing electric current values of the electric motors MG. The first-V-phase current sensor 94m1v is provided in the V-phase wire of the first electric motor MG1, so as to detect the first-electric-motor V-phase current Im1v. The first-electric-motor V-phase current Im1v is an output value of the first V-phase current sensor 94m1v, and is a signal representing the electric current value of the V phase of the first electric motor MG1. The first-W-phase current sensor 94m1w is provided in the W-phase wire of the first electric motor MG1, so as to detect the first-electric-motor W-phase current Im1w. The first-electric-motor W-phase current Im1w is an output value of the first W-phase current sensor 94m1w, and is a signal representing the electric current value of the W phase of the first electric motor MG1. The second-V-phase current sensor 94m2v is provided in the V-phase wire of the second electric motor MG2, so as to detect the second-electric-motor V-phase current Im2v. The second-electric-motor V-phase current Im2v is an output value of the second V-phase current sensor 94m2v, and is a signal representing the electric current value of the V phase of the second electric motor MG2. The second-W-phase current sensor 94m2w is provided in the W-phase wire of the second electric motor MG2, so as to detect the second-electric-motor W-phase current Im2w. The second-electric-motor W-phase current Im2w is an output value of the second W-phase current sensor 94m2w, and is a signal representing the electric current value of the W phase of the second electric motor MG2. The third-V-phase current sensor 94m3v is provided in the V-phase wire of the third electric motor MG3, so as to detect the third-electric-motor V-phase current Im3v. The third-electric-motor V-phase current Im3v is an output value of the third V-phase current sensor 94m3v, and is a signal representing the electric current value of the V phase of the third electric motor MG3. The third-W-phase current sensor 94m3w is provided in the W-phase wire of the third electric motor MG3, so as to detect the third-electric-motor W-phase current Im3w. The third-electric-motor W-phase current Im3w is an output value of the third W-phase current sensor 94m3w, and is a signal representing the electric current value of the W phase of the third electric motor MG3. Thus, the current sensors 94 are provided in two phases of the three phases of each one of the three electric motors MG.

The electronic control apparatus 80 outputs various command signals (such as a relay switching command signal Sr and an electric-motor drive command signal Smg) to various devices (such as the main relay 30 and the electric-power control device 40) provided in the vehicle 10. The relay switching command signal Sr is a command signal for switching the main relay 30 between the ON state and the OFF state. The electric motor drive command signal Smg is a command signal for controlling the electric-power control device 40 to drive the electric motors MG.

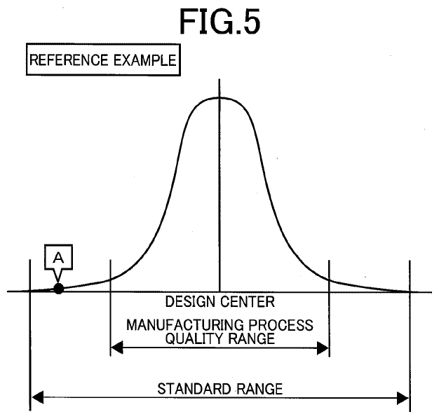

FIG. 5 is a view showing, by way of example, a distribution chart of errors (or variations) of the current sensors 94. In FIG. 5, the vehicle 10 is typically equipped with the current sensors 94 that is within a quality range in manufacturing process. However, a standard range has to be taken into consideration in design process. In other words, the vehicle 10 could be equipped with the current sensor 94 that is outside the quality range in manufacturing process but is within the standard range (see black circle A). For this reason, a design is required that will not fail as an electrical system controlling the electric motors MG even if the current sensor 94 is outside the quality range in manufacturing process. The s due to temperature characteristics of the current sensors 94 can be individually corrected. However, when viewed on an error distribution diagram, it is unclear how much the error of the current sensors 94 is deviated from a design center. In the present embodiment, a design method is proposed so as not to fail as an electrical system even if the current sensor 94 is considerably deviated from the design center.

When the vehicle 10 is powered ON, for example, to drive the vehicle 10, the electronic control apparatus 80 places the main relay 30 into the ON state. As a result, the smoothing capacitor 62 is set to a voltage substantially equal to the voltage boosted by the boost converter 50. In this state, when the vehicle 10 is powered OFF, for example, to park the vehicle 10, the electronic control apparatus 80 switches the main relay 30 to the OFF state. In this instance, the electronic control apparatus 80 performs a so-called discharge control CNdc for discharging the smoothing capacitor 62 by using the electric motors MG. The power ON state of the vehicle 10 corresponds to an ignition ON state, for example, while the power OFF state of the vehicle 10 corresponds to an ignition OFF state, for example.

The electronic control apparatus 80 acquires characteristics of the electric motor currents Img in execution of the discharge control CNdc, compares the characteristics of the electric motor currents Img corresponding to the respective electric motors MG, and corrects the error of one of the current sensors 94 which has a large deviation. To this end, the electronic control apparatus 80 includes a discharge controller 82, a state acquirer 84 and a corrector 86.

When the connection between the battery 20 and the smoothing capacitor 62 is cut off, the discharge controller 82 executes the discharge control CNdc for discharging the charge in the smoothing capacitor 62 through one of the electric motors MG. The connection between the battery 20 and the smoothing capacitor 62 is cut off when the main relay 30 is placed in the OFF state. Controlling the electric-power control device 40 is equivalent to controlling the inverter 60. Controlling the inverter 60 is equivalent to controlling one of the power modules 64. In the discharge control CNdc, the discharge controller 82 controls the first power module 64m1, for example. Controlling the first power module 64m1 is equivalent to controlling switching operations of the switching elements 70, 72 of the first power module 64m1. In the discharge control CNdc executed by controlling the first power module 64m1, the charge of the smoothing capacitor 62 is discharged through the first electric motor MG1 by the switching operations of the switching elements 70, 72. The same applies to cases in which the discharge control CNdc is executed by controlling the second power module 64m2 and third power module 64m3. In the case in which the discharge control CNdc is executed by controlling the first power module 64m1, a unit used by the discharge control CNdc, i.e., a discharge unit is a first discharge unit that includes the first power module 64m1 and the first electric motor MG1. In the case in which the discharge control CNdc is executed by controlling the second power module 64m2, the discharge unit is a second discharge unit that includes the second power module 64m2 and the second electric motor MG2. In the case in which the discharge control CNdc is executed by controlling the third power module 64m3, the discharge unit is a third discharge unit that includes the third power module 64m3 and the third electric motor MG3.

In the discharge control CNdc, the discharge controller 82 controls a direction of a vector of a magnetic field formed by a permanent magnet (field) provided in the rotor of the electric motor MG and a direction of a vector of the discharge current, for example, such that no force is generated to act in a direction of a vector of a force. In other words, in the discharge control CNdc, the discharge controller 82 controls inverter 60 such that electric motor MG is operated at a field angle of the electric motor MG at which the electric power is consumed in a way that does not generate torque in the electric motor MG.

The state acquirer 84 acquires a motor current characteristic Qimg when the discharge control CNdc is performed. The motor current characteristic Qimg is a characteristic of the current flowing from the electric-power control device 40 to each of the electric motors MG. The motor current characteristic Qimg includes a discharge time TMdc, an electric-motor electric angle θmge and an electric motor current Img. The discharge time TMdc is a length of time required to completely discharge the charge in the smoothing capacitor 62, and is a length of time from start of discharge of the smoothing capacitor 62 to its completion. The electric motor electric angle θmge is an electric angle of the electric motor MG. The output value of the current sensor 94 is used for the electric motor current Img.

The state acquirer 84 acquires, as the discharge time TMdc, for example, a length of time from a time point of the start of the discharge control CNdc to a time point at which the capacitor voltage Vc has dropped to a voltage value that can be determined to be zero. Alternatively, the state acquirer 84 acquires, as the discharge time TMdc, for example, a length of time from the time point of the start of the discharge control CNdc to a time point at which the electric motor current Img has dropped to a current value that can be determined to be zero.

The state acquirer 84 acquires, for example, the electric motor electric angle θmge in the motor current characteristic Qimg, which is calculated based on the electric motor rotation angle θmgm and a number of magnetic poles of the electric motor MG. The electric-motor electric angle θmge includes a first electric motor electric angle θm1e, a second electric motor electric angle θm2e and a third electric motor electric angle θm3e. The first electric motor electric angle θm1e is the electric angle of the first electric motor MG1. The second electric motor electric angle θm2e is the electric angle of the second electric motor MG2. The third electric motor electric angle θm3e is the electric angle of the third electric motor MG3.

The state acquirer 84 acquires, for example, a maximum value of the electric motor current Img during execution of the discharge control CNdc, as the electric motor current Img in the motor current characteristic Qimg.

The corrector 86 forms a current circle CLimg in each one of the electric motors MG, by using the discharge time TMdc, the electric-motor electric angle θmge, and the electric motor current Img that are acquired in the discharge control CNdc executed through each one of the three electric motors MG. The current circle is represented on rectangular coordinates by converting three-phase AC current in each one of the electric motors MG.

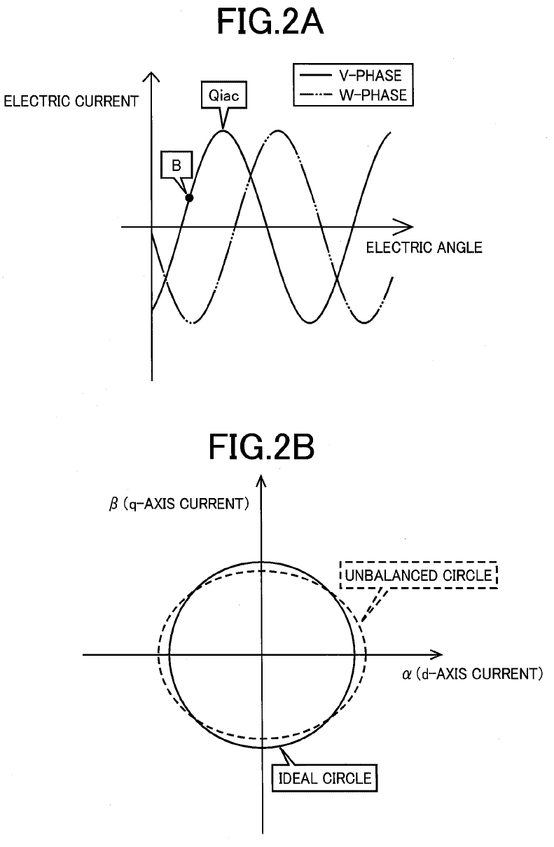

FIGS. 2A and 2B are for explaining the current circle CLimg, wherein FIG. 2A is a view showing, by way of examples, the motor current characteristic Qimg that is used for forming the current circle CLimg, and FIG. 2B is a view for explaining the formed current circle CLimg.

In FIG. 2A, the motor current characteristic Qimg is acquired each time the discharge control CNdc is executed (see black circle B). Each time the discharge control CNdc is executed, the state acquirer 84 acquires and stores the discharge time TMdc together with the electric-motor electric angle θmge and the electric motor current Img shown in black circle B. Each time the discharge control CNdc is executed, the state acquirer 84 acquires the motor current characteristic Qimg such that an AC current characteristic Qiac of the electric-motor electric angle θmge and the electric motor current Img shown in FIG. 2A can be created. Once the AC current characteristics Qiac for the V and W phases have been created, the AC current characteristic Qiac for the U phase can be created. The corrector 86 creates the U-phase AC current characteristic Qiac by using the V-phase and W-phase AC current characteristics Qiac. The corrector 86 forms the current circle CLimg in each one of the electric motors MG, by using the AC current characteristics Qiac of the three phases, combined with the discharge time TMdc.

In FIG. 2B, two-dimensional coordinate system of α axis and β axis is defined by d-axis current and q-axis current. The current circle CLimg represented in this coordinate system is a known current circle. An unbalanced circle shown by broken line is the current circle CLimg formed by using the AC current characteristic Qiac based on the motor current characteristic Qimg acquired in execution of the discharge control CNdc. An ideal circle shown by solid line represents a shape of a predetermined current circle CLimg, i.e., a predetermined ideal circle in a case in which there is no phase shift error in the output value of the current sensor 94. The corrector 86 corrects the current circle CLimg, by comparing the formed current circle CLimg with the predetermined ideal circle and correcting the phase of the output value of current sensor 94 corresponding to each one of the electric motors MG. The corrector 86 corrects the current circle CLimg such that, for example, the formed current circle CLimg is within a predetermined error range from the predetermined ideal circle. The correction of the current circle CLimg with respect to the predetermined ideal circle is made in shape of the circle not in length of radius of the circle.

To form the current circle CLimg, the AC current characteristic Qiac for each one of the three phases is required to be created. Further, to form the current circle CLimg for each one of the three electric motors MG, the AC current characteristic Qiac for each one of the three phases is required to be created for each one of the three electric motors MG. When the discharge control CNdc is executed, the corrector 86 selects a discharge unit by switching between the V and W phases so that the AC current characteristic Qiac for each one of the three phases is generated for each one of the three electric motors MG. For example, the corrector 86 switches the discharge unit in sequence each time the discharge control CNdc is executed, until the current circle CLimg for each one of the three electric motors MG can be formed. Alternatively, the corrector 86 may focus on selecting one discharge unit and forming the current circle CLimg for one of the three electric motors MG, until the current circle CLimg for each one of three electric motors MG can be formed. The selected discharge unit may be switched in a concentrated manner until the current circle CLimg can be formed. In this way, the corrector 86 selectively switches the three electric motors MG used in the discharge control CNdc so that the current circle CLimg can be formed in each one of the three electric motors MG. The corrector 86 calculates the three-phase AC current by using the output values of the two current sensors 94 provided in the respective two phases of each one of the three electric motors MG, so as to form the current circle CLimg. The current circle CLimg can also be seen as representing the motor current characteristic Qimg.

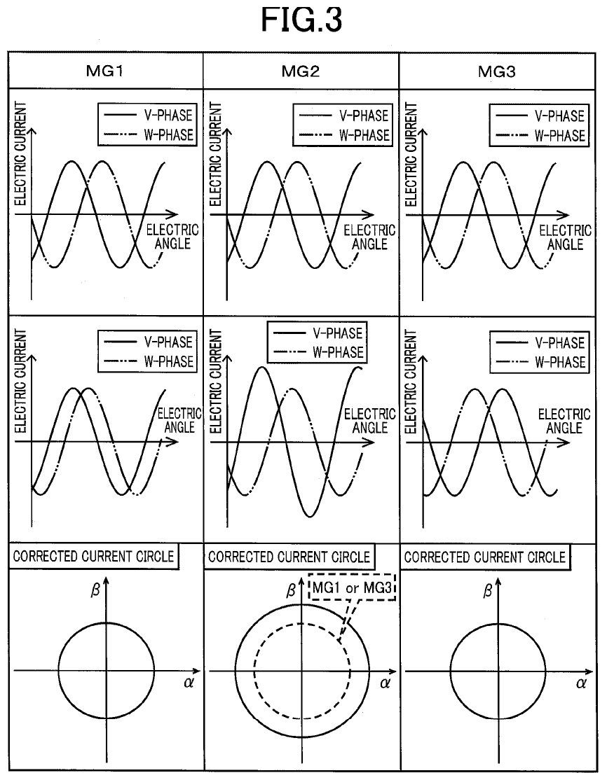

FIG. 3 is a view showing, by way of examples, the current circles CLimg for the respective electric motors MG. As shown in FIG. 3, the corrected current circle CLimg for the first electric motor MG1 and the corrected current circle CLimg for the third electric motor MG3 are substantially the same in size as each other. On other hand, the corrected current circle CLimg for the second electric motor MG2 is larger than the corrected current circle CLimg for each of the first electric motor MG1 and the third electric motor MG3. That is, the corrected current circle CLimg for the second electric motor MG2 is considerably deviated from the corrected current circles CLimg for the first electric motor MG1 and the third electric motor MG3. The radius, which represents the size of the current circle CLimg, varies depending on an amplitude of the electric motor current Img. For example, when the amplitude of the electric motor current Img is large whereby the amount of the electric motor current Img per unit time in the discharge control CNdc is increased, the discharge time TMdc is reduced and the radius of the current circle CLimg is increased. The corrector 86 compares the sizes of the respective current circles CLimg corresponding to the respective three electric motors MG. For example, the corrector 86 uses the corrected current circles CLimg so as to compare the sizes of the respective current circles CLimg corresponding to the respective electric motors MG. When determining that one of the current circles CLimg is deviated considerably from the other two current circles CLimg by a predetermined extent, namely, by such an extent that requires a correction, the corrector 86 corrects the amplitude of the output value of the current sensor 94 corresponding to the one of the current circles CLimg which is determined to be deviated considerably. The corrector 86 corrects the amplitude of the output value of the current sensor 94 corresponding to the current circle CLimg determined to deviate significantly so as to reduce or eliminate the deviation in the size of that current circle CLimg.

Thus, the corrector 86 compares the motor current characteristics Qimg of the respective three electric motors MG, which are acquired when the discharge control CNdc is executed through the respective three electric motors MG. When determining that one of the motor current characteristics Qimg is deviated from the other two by such an extent that requires the correction, the corrector 86 corrects the output value of the current sensor 94 corresponding to the motor current characteristic Qimg determined to be deviated considerably. In addition, the corrector 86 selectively switches the electric motor MG used in the discharge control CNdc so that the motor current characteristics Qimg can be compared. This ensures that the three electric motors MG are used in the discharge control CNdc substantially evenly, thereby allowing the motor current characteristics Qimg to be appropriately compared.

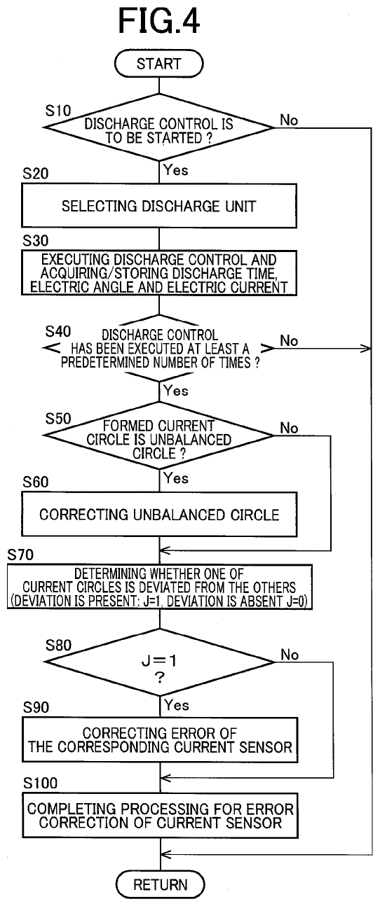

FIG. 4 is a flow chart showing main portions of control operations performed by the electronic control apparatus 80, namely, a control routine executed by the electronic control apparatus 80 for suppressing errors and variations among detected values of the respective current sensors 94. This control routine is executed in a repeated manner, for example.

As shown in FIG. 4, the control routine is initiated with step S10 corresponding to function of the discharge controller 82, which is implemented to determine whether the discharge control CNdc is to be started. When a negative determination has been made at step S10, one cycle of execution of the control routine is terminated. When an affirmative determination has been made at step S10, step S20 corresponding to function of the corrector 86 is implemented to select one of the discharge units. Then, step S30 corresponding to function of the state acquirer 84 is implemented to execute the discharge control CNdc by using the one of the discharge units which has been selected at step S20, so that the motor current characteristic Qimg (the discharge time TMdc, the electric-motor electric angle θmge and the electric motor current Img) of the above-described selected one of the discharge units are acquired and stored. Step S30 is followed by step S40 corresponding to function of the corrector 86, which is implemented to determine whether the discharge control CNdc has been executed through each one of the discharge units, at least a predetermined number of times. The predetermined number of times is, for example, a number of times at which it can be determined that the current circle CL1mg can be formed in the electric motor MG included in each one of the discharge units. When a negative determination has been made at step S40, one cycle of execution of the control routine is terminated. When an affirmative determination has been made at step S40, step S50 corresponding to function of the corrector 86 is implemented to determine whether the current circle CLimg formed in each one of the discharge units is an unbalanced circle that is not within a predetermined error range with respect to a predetermined ideal circle. When an affirmative determination has been made at step S50, step S60 corresponding to function of the corrector 86 is implemented to correct the unbalanced circle CLimg such that the corrected circle CLimg is within the predetermined error range with respect to the predetermined ideal circle. When a negative determination has been made at step S50 and when step S60 has been implemented, the control flow goes to step S70 corresponding to function of the corrector 86, which is implemented to compare sizes of the three current circles CLimg corresponding to the respective three electric motors MG, and determine whether one of the three current circles CLimg is deviated from the other two of the three current circles CLimg by such an extent that requires a correction, namely, determine whether the amplitude of the output value of one of the current sensors 94 is deviated from those of the other current sensors 94 by such an extent that requires a correction. When it is determined that there is such a deviation, a flag J is set to “1”. When it is determined that there is not such a deviation, a flag J is set to “0”. Then, step S80 corresponding to function of the corrector 86 is implemented to determine whether the flag J is “1”. When an affirmative determination has been made at step S80, step S90 corresponding to function of the corrector 86 is implemented to correct the error of the above-described one of the current sensors 94. When a negative determination has been made at step S80 and when step S90 has been implemented, the control flow goes to step S100 corresponding to function of the current sensors 94, which is implemented to complete a processing for error correction of the current sensor 94.

As described above, in the present embodiment, the three motor current characteristics Qimg of the respective three electric motors MG, each of which is acquired when the discharge control CNdc is executed through the corresponding one of the electric motors MG, are compared with one another. When it is determined that one of the three motor current characteristics Qimg is deviated from the other two of the three motor current characteristics Qimg by such an extent that requires a correction, the output value of the corresponding one of the current sensors 94 corresponding to the one of the three motor current characteristics Qimg, which is determined to be deviated from the other two, is corrected. Thus, it is possible to correct the output value of one of the current sensors 94 which is considerably deviated from the design center as viewed on the distribution chart of errors (or variations) of the current sensors 94, and to suppress errors and variations among the plurality of current sensors 94.

In the present embodiment, the three current circles CLimg corresponding to the respective electric motors MG are formed by using the three motor current characteristics Qimg each of which is acquired in the discharge control CNdc executed through a corresponding one of the three electric motors MG, wherein each of the three motor current characteristics Qimg includes the discharge time TMdc, the electric-motor electric angle θmge and the electric motor current Img. Then, the sizes of the respective three current circles CLimg are compared with one another. When it is determined that one of the three current circles CLimg is deviated in size from the other two of the three current circles CLimg by such an extent that requires a correction, the amplitude of the output value of the corresponding one of the current sensors 94 corresponding to the one of the three current circles CLimg which is determined to be deviated from the other two, is corrected. Thus, it is possible to appropriately correct the output value of one of the current sensors 94 which is considerably deviated from the design center.

In the present embodiment, each one of the three current circles CLimg is compared with the ideal circle, and is corrected by correcting the phase of the output value of a corresponding one of the current sensors 94. Then, the sizes of the respective three current circles CLimg, which have been corrected by correcting the phase of the output value of each one of the current sensors 94, are compared with one another. Thus, the sizes of the current circles CLimg are compared with one another after unbalance of each one of the current circles CLimg has been corrected, so that it is possible to increase accuracy of correction of the errors (or variations) of the current sensors 94.

In the present embodiment, the three current circles CLimg corresponding to the respective three electric motors MG is formed by selectively switching the three electric motors MG for the discharge control such that the discharge control CNdc is executed through each one of the three electric motors MG. Thus, the three electric motors MG are used in the discharge control CNdc substantially evenly, thereby allowing the three current circles CLimg to be appropriately compared with one another.

In the present embodiment, the three current circles CLimg are formed by calculating the three-phase AC currents by using the output values of the current sensors 94 provided for the two of the three phases. Thus, as compared with a case in which the three-phase AC currents by using the output values of the current sensors 94 provided for the three phases, it is advantageous in terms of cost, for example, since the required number of the current sensors provided in the vehicle 10 can be reduced.

While the preferred embodiment of this invention has been described in detail by reference to the drawings, it is to be understood that the invention may be otherwise embodied.

For example, in the above-described embodiment, the vehicle 10 may be equipped with at least three electric machines. For example, the vehicle 10 may have four electric machines configured to drive the respective front, rear, left and right wheels independently.

In the above-described embodiment, if there is no need to boost the voltage of the battery 20, the boost converter 50 is not provided.

In the above-described embodiment, the current sensors 94 may be provided in any two of the three phases of each one of the electric machines. For example, the current sensors 94 may be provided in the U and W phases, or in the U and V phases. Alternatively, the present invention can also be applied to a vehicle in which the current sensors 94 are provided in the U, V and W phases of each one of the electric machines. In this case, while it is not possible to reduce the number of the current sensors 94 provided in the vehicle 10, it is possible to achieve a certain effect such as suppressing the errors and variations among the current sensors 94.

In the above-described embodiment, the sizes of the current circles CLimg corresponding to the respective electric motors MG may be compared without correcting unbalance of each one of the current circles CLimg. In this case, too, it is possible to achieve a certain effect such as suppressing the errors and variations among the current sensors 94.

In the above-described embodiment, the motor current characteristic Qimg of the respective electric motors MG may be directly compared with one another, so as to suppress the errors and variations among the current sensors 94. For example, the discharge time TMdc and the electric motor current Img of the motor current characteristic Qimg may be used to suppress the errors and variations among the current sensors 94. In this case, the corrector 86 determines whether any one of the three current sensors 94 is deviated from the other two with respect to the motor current characteristic Qimg. When any one of the current sensors 94 is deviated, the corrector 86 may use a correction map to calculate a correction amount for the output value of the current sensor 94 and correct the output value of the current sensor 94 by reflecting that correction amount. The correction map may be, for example, a map in which a relationship between the deviation of the motor current characteristic Qimg and the correction amount is presented. The corrector 86 selects the discharge unit together with switching between the V phase and the W phase so that the motor current characteristics Qimg can be compared.

It is to be understood that the embodiment described above is given for illustrative purpose only, and that the present invention may be embodied with various modifications and improvements which may occur to those skilled in the art.

### NOMENCLATURE OF ELEMENTS

10: vehicle
20: battery (electric storage device)
40: electric-power control device
60: inverter
62: smoothing capacitor (capacitor)
70 (70u, 70v, 70w): switching element
72 (72u, 72v, 72w): switching element
80: electronic control apparatus (control apparatus)
82: discharge controller
86: corrector
94: current sensor (plurality of current sensors)
94m1v: first V-phase current sensor
94m1w: first W-phase current sensor
94m2v: second V-phase current sensor
94m2w: second W-phase current sensor
94m3v: third-V-phase current sensor
94m3w: third-W-phase current sensor
MG: electric motor
MG1: first electric motor (electric machine, electric motor of three-phase AC)
MG2: second electric motor (electric machine, electric motor of three-phase AC)
MG3: third electric motor (electric machine, electric motor of three-phase AC)

What is claimed is:

1. A control apparatus for a vehicle that includes (i) an electric storage device, (ii) three electric machines, (iii) an electric-power control device which includes a capacitor connected with the electric storage device and which is configured to supply an electric power from the electric storage device to the three electric machines and (iv) a plurality of current sensors each of which is configured to detect an electric current flowing from the electric-power control device to a corresponding one of the three electric machines,
the control apparatus comprising:
a discharge controller configured, when connection of the capacitor with the electric storage device is cut off, to execute a discharge control for discharging charge of the capacitor through each one of the three electric machines by controlling the electric-power control device; and
a corrector configured to compare three electric-current characteristics each of which is a characteristic of the electric current flowing to a corresponding one of the three electric machines and each of which is acquired when the discharge control is executed through the corresponding one of the three electric machines, and is configured, when determining that one of the three electric-current characteristics is deviated from the other two of the three electric-current characteristics by at least a predetermined extent, to correct an output value of a corresponding one of the current sensors corresponding to the one of the three electric-current characteristics which is determined to be deviated from the other two.

2. The control apparatus according to claim 1,
wherein the three electric machines are three electric motors of three-phase AC,
wherein the electric-power control device includes an inverter having a plurality of switching elements and configured to drive the three electric motors,
wherein the corrector is configured to form three current circles represented on rectangular coordinates by converting three-phase AC currents in the respective three electric motors, by using the three electric-current characteristics each of which is acquired in the discharge control executed through a corresponding one of the three electric motors, each one of the three electric-current characteristics including a time from start to completion of discharge through the corresponding one of the three electric motors, an electric angle of the corresponding one of the three electric motors, and the output value of the corresponding one of the current sensors, and
wherein the corrector is configured to compare sizes of the respective three current circles each corresponding to a corresponding one of the three electric motors, and is configured, when determining that one of the three current circles is deviated in size from the other two of the three current circles by a predetermined extent, to correct an amplitude of the output value of a corresponding one of the current sensors corresponding to the one of the three current circles which is determined to be deviated from the other two.

3. The control apparatus according to claim 2,
wherein the corrector is configured to compare each one of the three current circles with an ideal circle, and correct each one of the three current circles by correcting a phase of the output value of a corresponding one of the current sensors, and
wherein the corrector is configured to compare the sizes of the respective three current circles that have been corrected by correcting the phase of the output value of each one of the current sensors.

4. The control apparatus according to claim 2,
wherein the corrector is configured to form the three current circles each corresponding to a corresponding one of the three electric motors, by selectively switching the three electric motors for the discharge control such that the discharge control is executed through each one of the three electric motors.

5. The control apparatus according to claim 2,
wherein the plurality of current sensors are provided for two of three phases of each one of the three electric motors, and
wherein the corrector is configured to form the three current circles each corresponding to a corresponding one of the three electric motors, by calculating the three-phase AC currents in the respective three electric motors by using the output value of each one of the plurality of current sensors provided for the two of the three phases.
